(19) United States
(12) Patent Application Publication
(10) Pub. No.: US 2023/0212725 A1
(43) Pub. Date: Jul. 6, 2023

(54) Fe-BASED AMORPHOUS NANOCRYSTALLINE ALLOY AND PREPARATION METHOD THEREOF

(71) Applicant: QINGDAO YUNLU ADVANCED MATERIALS TECHNOLOGY CO., LTD., Qingdao, Shandong (CN)

(72) Inventors: Shuhai LIU, Qingdao (CN); Jianwei BU, Qingdao (CN); Dong YANG, Qingdao (CN); Wenkang YAO, Qingdao (CN); Hongyu LIU, Qingdao (CN)

(73) Assignee: QINGDAO YUNLU ADVANCED MATERIALS TECHNOLOGY CO., LTD., Qingdao, Shandong (CN)

(21) Appl. No.: 17/928,314

(22) PCT Filed: Feb. 16, 2022
(86) PCT No.: PCT/CN2022/076488

§ 371 Date: Nov. 29, 2022

(30) Foreign Application Priority Data
Mar. 1, 2021 (CN) 202110224190.5

(51) Int. Cl. C22C 45/02; C22C 33/00; C22C 33/04

(52) U.S. Cl. CPC C22C 45/02; C22C 33/003; C22C 33/006; C22C 33/04; C22C 2200/02; C22C 2200/04; C22C 2202/02

(57) ABSTRACT

The specification relates to the technical field of magnetic materials, in particular to an Fe-based amorphous nanocrystalline alloy and a preparation method thereof. The Fe-based amorphous nanocrystalline alloy comprises elements, the atomic percentages of which are as shown by the formula Fe_{(100-a-b-c-d-e-f)}BₐSi_{b}P_{c}C_{d}CuₑNb_{f}, wherein 8≤a≤12, 0.2≤b≤6, 2.0≤c≤6.0, 0.5≤d≤4, 0.6≤e≤1.3, 0.6≤f≤0.9, and 1≤e/f≤1.4. The Fe-based amorphous nanocrystalline alloy has good magnetic properties, excellent thermal properties and a wide crystallization temperature zone, thus being suitable for industrial production.

This application claims priority from Chinese patent application No. 202110224190.5 titled as “Fe-based Amorphous Nanocrystalline Alloy and Preparation Method thereof” and filed on Mar. 1, 2021 before State Intellectual Property Office, content of which is incorporated herewith by reference.

### TECHNICAL FIELD

The specification relates to the technical field of magnetic materials, in particular to an Fe-based amorphous nanocrystalline alloy and a preparation method thereof.

### BACKGROUND ART

At present, soft magnetic materials used in transformers, motors or generators, current sensors, magnetic sensors and pulse power magnetic components include silicon steel, ferrite, Co-based amorphous alloys and nanocrystalline alloys. Among these soft magnetic materials, silicon steel is cheap and high in magnetic flux density and machinability, but is subjected to high loss under high frequency. Ferrite has limited applications in high-power and high-saturation magnetic induction scenarios due to low saturation flux density. Co-based amorphous alloys are not only expensive, but also low in saturation magnetic flux density, so when used as a high-power device, co-based amorphous alloys are unstable in thermodynamics and subjected to high loss in use.

Fe-based amorphous alloys have the advantages of high saturation magnetic flux density and low loss under high power, thus being an ideal magnetic material. At present, Fe-based amorphous/nanocrystalline alloys have developed into three major systems, namely, Finemet (Fe_{73.5}Si1_{3.5}B₉Cu₁Nb₃) alloys, Nanoperm (Fe-M-B, M=Zr, Hf, Nb, etc.) alloys and HITPERM (Fe—Co-M-B, M=Zr, Hf, Nb, etc.) alloys. Among them, Finemet alloys have been widely used in many fields because of their good soft magnetic properties and low cost. However, the saturation magnetic induction of Finemet alloys is low (only about 1.25 T). Compared with silicon steel with high saturation magnetic induction, the application of Finemet alloys requires a larger volume under the same conditions, which seriously limits the application of Finemet alloys. In addition, compared with silicon steel, Finemet alloys are higher in cost due to the presence of precious metal Nb, which is not conducive to the development of society.

### SUMMARY OF THE INVENTION

Embodiments of the specification provide an Fe-based amorphous nanocrystalline alloy and a preparation method thereof. The Fe-based amorphous nanocrystalline alloy has excellent soft magnetic properties and is suitable for industrial production.

In a first aspect, an embodiment of the specification provides an Fe-based amorphous nanocrystalline alloy, which comprises elements, the atomic percentages of which are shown by formula (1):

Fe_{(100-a-b-c-d-e-f)}BₐSi_{b}P_{c}C_{d}CuₑNb_{f} (1);

where 8≤a≤12, 0.2≤b≤6, 2.0≤c≤6.0, 0.5≤d≤4, 0.6≤e≤1.3, 0.6≤f≤0.9, and 1≤e/f≤1.4.

In some embodiments, the Fe-based amorphous nanocrystalline alloy is in a continuous thin strip shape, and a strip thickness of the thin strip is greater than or equal to 30 nm.

In some embodiments, a temperature difference between a second crystallization start temperature and a first crystallization start temperature of the Fe-based amorphous nanocrystalline alloy is greater than 120° C.

In some embodiments, a ratio of the temperature difference to first heat is greater than or equal to 1.38, the first heat is heat released by the Fe-based amorphous nanocrystalline alloy during first crystallization, the unit of the temperature difference is Celsius, and the unit of the first heat is J/g.

In some embodiments, the saturation magnetic induction of the Fe-based amorphous nanocrystalline alloy is greater than or equal to 1.75 T, the iron-loss per unit weight of the Fe-based amorphous nanocrystalline alloy is less than 0.30 W/kg under an excitation condition of 50 Hz-1.5 T, and

in the Fe-based amorphous nanocrystalline alloy, a size of nanocrystalline grains is 20-30 nm.

In a second aspect, a preparation method of the Fe-based amorphous nanocrystalline alloy as described in the first aspect comprises the following steps:

(a) blending according to the atomic percentages of elements shown in the formula (1), and then smelting to obtain molten steel;

(b) performing single-roll rapid quenching on the molten steel to obtain an initial strip;

(c) heating the initial strip to a first preset temperature which is 20-30° c. higher than a first crystallization start temperature of the initial strip;

(d) holding the temperature for 30-40 min; and

(e) cooling the initial strip to obtain the Fe-based amorphous nanocrystalline alloy;

wherein

Fe_{(100-a-b-c-d-e-f)}BₐSi_{b}P_{c}C_{d}CuₑNb_{f} (1);

where 8≤a≤12, 0.2≤b≤6, 2.0≤c≤6.0, 0.5≤d≤4, 0.6≤e≤1.3, 0.6≤f≤0.9, and 1≤e/f≤1.4.

In some embodiments, heating the initial strip to a first preset temperature comprises:

heating the initial strip to a second preset temperature, and holding the temperature for a preset time, the second preset temperature being lower than the first preset temperature; and

heating the initial strip from the second preset temperature to the first preset temperature at a first preset heating rate.

In some embodiments, the second preset temperature is 280° C., the preset time is 2 h, and

the first preset heating rate is 30° C./min.

In some embodiments, in step (e), the initial strip is cooled at a cooling rate of 50° C./s.

In a fourth aspect, a magnetic component composed of the Fe-based amorphous nanocrystalline alloy as described in the first aspect is provided.

The Fe-based amorphous nanocrystalline alloy provided by the embodiment of this specification has good magnetic properties, excellent thermal properties, and a wide crystallization temperature zone, thus being suitable for industrial production.

### BRIEF DESCRIPTION OF THE DRAWINGS

FIG. 1 shows a process flow of an Fe-based amorphous nanocrystalline alloy provided by an embodiment of this specification;

FIG. 2 shows XRD patterns of Embodiments 1, 2 and 3, where 1 represents Embodiment 1, 2 represents Embodiment 2 and 3 represents Embodiment 3;

FIG. 3 shows XRD patterns of Embodiments 6, 7 and 8, where 6 represents Embodiment 6, 7 represents Embodiment 7 and 8 represents Embodiment 8;

FIG. 4 shows XRD patterns of Embodiments 12, 13 and 14, where 12 represents Embodiment 12, 13 represents Embodiment 13 and 14 represents Embodiment 14;

FIG. 5 shows DSC patterns of Embodiments 1, 3 and 6, where 1 represents Embodiment 1, 3 represents Embodiment 3 and 6 represents Embodiment 6; and

FIG. 6 shows DSC patterns in Embodiments 2, 8, 12 and 14, where 2 represents Embodiment 2, 8 represents Embodiment 8, 12 represents Embodiment 12 and 14 represents Embodiment 14.

### DETAILED DESCRIPTION OF THE INVENTION

The technical schemes in the embodiments of the present invention will be described below with reference to attached drawings. It is obvious that the described embodiments are only illustrative ones, and are not all possible ones of the specification.

One scheme provides an Fe-based amorphous alloy FeₐB_{b}Si_{c}PₓC_{y}Cu_{z}, where 79≤a≤86 at %, 5≤b≤13 at %, 0≤c≤8 at %, 1≤x≤8 at %, 0≤y≤5 at %, 0.4≤z≤1.4 at % and 0.08≤z/x≤0.8. By taking the Fe-based amorphous alloy as an initial component, an Fe-based nanocrystalline alloy with both high saturation magnetic induction and high magnetic permeability can be obtained. In order to crystallize and refine the Fe-based amorphous alloy to nano-scale, the Fe-based amorphous alloy needs to be heated at a high heating rate of 100° C./min, and the temperature obtained after heating must be kept within a narrow temperature range of 30-40° C. Therefore, it is extremely difficult to prepare nanocrystalline alloys based on the Fe-based amorphous alloy for the industrial field. In addition, near a set temperature, a large amount of heat is generated instantly due to crystallization, which leads to a sharp rise in the temperature of large components, resulting in continuous temperature increase and even melting.

According to the embodiment of this specification, the range of a difference between a second crystallization start temperature (Tₓ₂) and a first crystallization start temperature (Tₓ₁) of the Fe-based amorphous alloy is widened through composition control, the heat treatment process window of crystallization is enlarged, and the problem that the heat treatment temperature of a strip exceeds a second crystallization temperature due to the excessive heat release Q₁ of the alloy during first crystallization, resulting in the burning of the strip due to continuous temperature increase is solved.

The embodiment of this specification sets a heat treatment characterization parameter κ, where

$$κ = \frac{Tx 2 - Tx 1}{{Q}_{1}} .$$

The relationship between x and alloy composition can be used to explore for better alloy composition, and the heat treatment process of alloy crystallization can be controlled by controlling the value of κ.

Through the above exploration, an embodiment of this specification provides an Fe-based amorphous alloy Fe_{(100-a-b-c-d-e-f)}BₐSi_{b}P_{c}C_{d}CuₑNb_{f}, where a, b, c, d and e respectively represent the atomic percentages of corresponding components, 8≤a≤12, 0.2≤b≤6, 2.0≤c≤6.0, 0.5≤d≤4, 0.6≤e≤1.3, 0.6≤f≤0.9, and 1≤e/f≤1.4.

As an essential element, Fe can improve saturation magnetic induction and reduce material cost. If the content of Fe is lower than 78 at %, desired saturation magnetic induction cannot be obtained. If the content of Fe is higher than 86 at %, it is difficult to form an amorphous phase and coarse a-Fe grains will be formed by a quenching method. As a result, a uniform nanocrystalline structure cannot be obtained, leading to the decline of soft magnetic properties.

As an essential element, B can improve the amorphous forming ability. If the content of B is lower than 5 at %, it is difficult to form an amorphous phase by a quenching method. If the content of B is higher than 12 at %, the difference between Tₓ₂ and Tₓ₁ (ΔT=Tₓ₂−Tₓ₁) will decrease, which is not conducive to the formation of a uniform nanocrystalline structure, resulting in the decline of soft magnetic properties.

Si can inhibit the precipitation of Fe and B compounds in a crystallized nanocrystalline structure, thus stabilizing the nanocrystalline structure. When the content of Si is greater than 8 at %, the saturation magnetic induction and amorphous forming ability will decrease, resulting in the decline of soft magnetic properties. In particular, when the content of Si is above 0.8 at %, the amorphous forming ability will be improved, and thin strips can be produced stably and continuously. In addition, due to the increase of ΔT, a uniform nanocrystalline structure can be obtained.

As an essential element, P can improve the amorphous forming ability. If the content of P is lower than 1 at %, it is difficult to form an amorphous phase by a quenching method. If the content of P is greater than 8 at %, the saturation magnetic induction and soft magnetic properties will decrease. In particular, if the content of P is 2-5 at %, the amorphous forming ability can be improved.

C can increase the amorphous forming ability, and the addition of C can reduce the content of metalloid and reduce the material cost. When the content of C exceeds 5 at %, embrittlement will be caused, resulting in the decline of soft magnetic properties. In particular, when the content of C is below 3 at %, segregation caused by C volatilization can be suppressed.

Cu is conducive to the formation of a large number of fcc-Cu clusters and bcc-(Fe) crystal nuclei in a quenching process, and also promotes the precipitation of bcc-(Fe) crystal nuclei in a heat treatment process, so as to improve the saturation magnetic induction. When the content of Cu is lower than 0.6 at %, it is unfavorable for nanocrystallization. When the content of Cu is greater than 1.4 at %, the amorphous phase will be uneven, which is not conducive to the formation of a uniform nanocrystalline structure, resulting in the decline of soft magnetic properties. It should be noted that if the embrittlement of the nanocrystalline alloy is considered, the content of Cu should be controlled below 1.3 at %. Besides, in order to make the alloy form a nanocrystalline structure with a small grain size and uniform distribution in a wider crystallization temperature zone (i.e. the temperature range between Tₓ₂ and Tₓ₁), it is necessary to add certain large atomic elements to inhibit abnormal growth of grains. The ratio of Cu atoms to Nb atoms, i.e., the value of e/f, can be denoted as λ. The inventor of the present invention has verified through a large number of experiments that when 1≤λ≤1.4, a nanocrystalline alloy with a wide heat treatment range (κ≥1.38) and a stable grain size can be obtained.

As a large atomic element, Nb improves the amorphous forming ability of the alloy, inhibits the precipitation of a primary crystal phase in an amorphous precursor, and can inhibit excessive growth of atoms and control the grain size during heat treatment. The addition of Nb improves the thermal stability of the amorphous phase, thus increasing the nucleation activation energy and growth activation energy of the primary crystal phase a-Fe. The atomic content of Nb is controlled to be 0.6-0.9 at %.

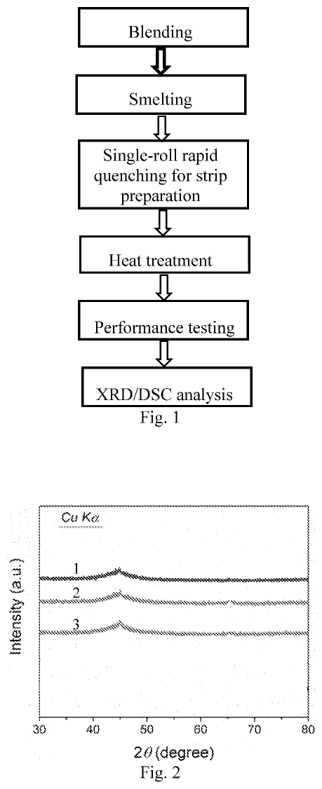

Referring to FIG. 1, the scheme provided by the embodiment of this specification may comprise the following steps.

1. Blending

Blending can be performed according to the composition shown in Fe_{(100-a-b-c-d-e-f)}BₐSi_{b}P_{c}C_{d}CuₑNb_{f}. The required industrial raw materials are pure Fe, pure Cu, elemental Si, pure C and Fe—B and Fe—P alloys, and the purity of the raw materials is shown in Table 1.

TABLE 1
Raw materials and purity table

| Raw | | | | | B—Fe | P—Fe |
|---|---|---|---|---|---|---|
| materials | Fe | Cu | Si | C | (wt %-B) | (wt %-P) |
| Purity % | 99.95 | 99.99 | 99.6 | 99.95 | 17.94 | 24.32 |

2. Smelting

The raw materials can be weighed according to a mass ratio, and then added into a heating furnace (specifically, an intermediate frequency induction heating furnace) for melting. During the melting process, an inert gas (such as argon) is introduced as a protective gas, and after melting, the materials stand for 30 min to ensure that the composition of molten steel is uniform without segregation.

3. Single-Roll Rapid Quenching for Strip Preparation

An amorphous alloy thin strip can be prepared by a copper roll rapid quenching method, that is, the molten steel is poured at 1400-1500° C., an amorphous nanocrystalline strip is obtained by the copper roll rapid quenching method, and the prepared amorphous nanocrystalline strip is wound into loops. As an example, an inner diameter of the loops may be 65 mm, and an outer diameter may be 70 mm. In the embodiment of this specification, the thin strip may also be called strip.

4. Heat Treatment

The amorphous alloy thin strip prepared above can be subjected to heat treatment. Heat treatment may also be called crystallization annealing treatment, which is to promote the amorphous alloy to produce nano-scale grains, so as to prepare the amorphous nanocrystalline alloy. Specifically, during heat treatment or crystallization annealing, a temperature 20-30° C. higher than a first crystallization start temperature of the amorphous alloy is set as a heating target temperature. For example, the heating target temperature may be 420° C. As an example, in order to ensure the uniformity of temperature rise, the heat treatment process of the amorphous alloy is divided into two stages. In a first stage, the temperature of the amorphous alloy thin strip is increased to 280° C., and the temperature is kept for 2 h. In a second stage, the temperature of the amorphous alloy thin strip is increased to the heating target temperature at a rate of 30° C./min, and the temperature is kept for 30-40 min. Finally, the temperature is reduced at a rate of 50° C./s, and after cooling to room temperature, the amorphous nanocrystalline alloy thin strip can be obtained. To prevent oxidation during heat treatment, the above heat treatment process is performed in an inert gas (such as argon) atmosphere.

5. Performance testing, specifically, performance evaluation and analysis of the obtained amorphous nanocrystalline alloy thin strip.

(1) Measurement of saturation magnetic induction and coercivity. A vibrating sample magnetometer (VSM) is used to measure the saturation magnetization intensity Bs of the amorphous nanocrystalline alloy thin strip. The coercivity of the amorphous nanocrystalline alloy thin strip is measured by a soft magnetic DC tester. Based on the principle of electromagnetic induction, the VSM obtains the curvilinear relationship between a magnetic moment of a sample and an external magnetic field, and the range of a test magnetic field is −12500 to 12500 Oe. Before testing, equipment is calibrated with a prepared Ni mark, then the magnetic sample to be tested is crushed, and then about 0.032 g of the sample is obtained, wrapped tightly with tin foil, and put in a copper mold for measurement.

(2) Measurement of loss power and excitation power. A B—H tester is used for measurement. By setting sample parameters (effective magnetic circuit length, effective cross-sectional area, number of windings, etc.) and test conditions (test frequency, magnetic field intensity, maximum magnetic flux density, maximum induced voltage, etc.), a B—H curve is output, and various magnetic characteristic parameters are tested. Loss power (Ps) and excitation power (Ss) are the most important among all the parameters.

6. XRD/DSC analysis, specifically, detection and analysis of the amorphous alloy thin strip before heat treatment.

(1) Diffraction of x-rays (XRD) is used to verify whether the prepared amorphous alloy thin strip is a completely amorphous structure. In order to ensure that the alloy strip is a completely amorphous structure, XRD patterns of all samples come from the free surface of the alloy strip (opposite to the copper roll surface). Related test conditions and parameters are: a graphite monochromator with X-ray wavelength is used for filtering, the tube voltage is 40 kV, the tube current is 30 mA, the test range is 20-90°, the step length is 0.02°, and the scanning speed is 8°/min. The amorphous alloy strip in this application can be determined by XRD patterns. If a characteristic spectrum shows a broad diffraction peak (also called “steamed bread peak”), it can be concluded that the strip is a completely amorphous structure.

(2) Thermal analysis of the amorphous alloy thin strip is performed with a differential scanning calorimeter (DSC), so as to test the crystallization behavior and thermal stability of the alloy thin strip. Before testing, the thin strip is cut into small pieces with an area of less than 1 mm81 mm, and then about 20 mg of the thin strip pieces are obtained, put into a sample table in an alumina crucible, and heated at a heating rate of 20° C./min under the protection of N₂ from room temperature to 300-800° C., preferably to 800° C. By analyzing a DSC curve of the sample, the phase transition of each sample during heating can be obtained, and thermal characteristic temperature parameters, such as Curie temperature Tc, glass transition temperature Tg and crystallization start temperature Tx of the alloy strip, can be obtained. According to a characteristic temperature value of the DSC curve of the alloy strip, the thermal stability of the alloy strip can be reflected, providing a reference for the determination of the heat treatment process of the amorphous strip. An approximate annealing temperature range is determined. A first-stage initial crystallization temperature of the alloy strip is marked as Tₓ₁ (i.e. a temperature point at which a-Fe (Si) begins to separate out), and a second-stage initial crystallization temperature is marked as Tₓ₂ (i.e. a temperature point at which Fe—(B, P) compounds begin to separate out), and a difference between the two initial crystallization temperatures is marked as ΔTₓ (ΔTₓ=Tₓ₂−Tₓ₁).

Next, the scheme provided in this specification will be illustrated with specific embodiments.

I. Verify the Role and Control Range of Cu

In different embodiments, different amounts of Cu were added to verify the effect of Cu and its influence on heat treatment characteristic parameters κ and Tₘₐₓ, so as to control the content of Cu in the alloy. The alloy composition of each embodiment and comparative example (the content of each component is represented by atomic percentage) is shown in Table 2.

An amorphous alloy strip can be prepared and subjected to heat treatment according to the scheme shown in FIG. 1, which comprises the following steps.

11. Blending

Blending was performed according to the composition of each embodiment and comparative example shown in Table 2. The required industrial raw materials were pure Fe, pure Cu, elemental Si, pure C and Fe—B and Fe—P alloys, and the purity of the raw materials is shown in Table 1.

12. Smelting

The raw materials were weighed according to a mass ratio, and then added into a heating furnace (specifically, an intermediate frequency induction heating furnace) for melting. During the melting process, an inert gas (such as argon) was introduced as a protective gas, and after melting, the materials stood for 30 min to ensure that the composition of molten steel was uniform without segregation. In one example, the total mass of raw materials was 200 kg.

13. Single-Roll Rapid Quenching for Strip Preparation

An amorphous alloy thin strip was prepared by a copper roll rapid quenching method, that is, the molten steel was poured at 1400-1500° C., an amorphous nanocrystalline strip was obtained by the copper roll rapid quenching method, and the prepared amorphous nanocrystalline strip was wound into loops. As an example, an inner diameter of the loops may be 65 mm, and an outer diameter may be 70 mm. In the embodiments of this specification, the thin strip may also be called strip.

14. Heat Treatment

The amorphous alloy thin strip prepared above was subjected to heat treatment. Heat treatment may also be called crystallization annealing treatment, which is to promote the amorphous alloy to produce nano-scale grains, so as to prepare the amorphous nanocrystalline alloy. Specifically, during heat treatment or crystallization annealing, a temperature 20-30° C. higher than a first crystallization start temperature of the amorphous alloy was set as a heating target temperature. For example, the heating target temperature may be 420° C. As an example, in order to ensure the uniformity of temperature rise, the heat treatment process of the amorphous alloy was divided into two stages. In a first stage, the temperature of the amorphous alloy thin strip was increased to 280° C., and the temperature was kept for 2 h. In a second stage, the temperature of the amorphous alloy thin strip was increased to the heating target temperature at a rate of 30° C./min, and the temperature was kept for 30-40 min. Finally, the temperature was reduced at a rate of 50° C./s, and after cooling to room temperature, the amorphous nanocrystalline alloy thin strip can be obtained. To prevent oxidation during heat treatment, the above heat treatment process was performed in an inert gas (such as argon) atmosphere.

Thus, the strips in each embodiment or comparative example in Table 2 were prepared.

The above-mentioned XRD analysis was used to verify whether the prepared amorphous alloy strip was a completely amorphous structure. Verification results are shown in FIG. 2, from which it can be seen that only a broadened diffuse scattering peak appeared at about 45°, which indicates that the alloy sample was a completely amorphous structure.

DSC analysis results are shown in Table 2. Two obvious exothermic peaks appeared in the DSC curves of the samples, and a start temperature of a first exothermic peak and a start temperature of a second exothermic peak were Tₓ₁ and Tₓ₂ respectively, based on which ΔTₓ was obtained. An area of the first exothermic peak can be calculated, so that the heat release Q₁ of the alloy during first crystallization can be calculated, and then the heat treatment characteristic parameter κ can be obtained.

TABLE 2
Thermal properties and heat treatment process

| | | | Tₓ₁ | Tₓ₂ | ΔTₓ | Q₁ | | Tₘₐₓ |
|---|---|---|---|---|---|---|---|---|
| No. | Alloy composition | λ | (° C.) | (° C.) | (° C.) | J/g | κ | ° C. |
| Embodiment 1 | Fe_{83.8}B₁₀Si_{0.5}P_{3.5}C_{1.0}Cu_{0.6}Nb_{0.6} | 1.00 | 405 | 525 | 120 | 81 | 1.39 | 513 |
| Embodiment 2 | Fe_{83.2}B₁₀Si_{0.5}P_{3.5}C_{1.0}Cu_{1.0}Nb_{0.8} | 1.25 | 389 | 521 | 131 | 86 | 1.57 | 519 |
| Embodiment 3 | Fe_{82.8}B₁₀Si_{0.5}P_{3.5}C_{1.0}Cu_{1.3}Nb_{0.9} | 1.40 | 397 | 539 | 142 | 82 | 1.38 | 511 |
| Embodiment 4 | Fe_{82.9}B_{9.5}Si_{1.0}P_{2.6}C_{1.2}Cu_{1.1}Nb_{0.9} | 1.22 | 410 | 533 | 123 | 79 | 1.55 | 509 |
| Embodiment 5 | Fe_{82.8}B_{9.6}Si_{0.5}P_{4.2}C_{0.8}Cu_{1.2}Nb_{0.9} | 1.33 | 391 | 527 | 136 | 85 | 1.6 | 511 |
| Comparative example 1 | Fe_{83.7}B₁₀Si_{0.5}P_{3.5}C_{1.0}Cu_{0.5}Nb_{0.8} | 0.63 | 415 | 495 | 90 | 95 | 0.95 | 562 |
| Comparative example 2 | Fe_{82.8}B₁₀Si_{0.5}P_{3.5}C_{1.0}Cu_{1.4}Nb_{0.8} | 1.75 | 426 | 513 | 87 | 91 | 0.95 | 546 |
| Comparative example 3 | Fe_{82.3}B₁₀Si_{0.5}P_{3.5}C_{1.0}Cu_{1.5}Nb_{1.2} | 1.25 | 413 | 515 | 102 | 92 | 1.11 | 555 |
| Comparative example 4 | Fe_{79.6}B₁₃Si_{1.3}P_{2.8}C_{1.1}Cu_{1.0}Nb_{1.2} | 0.83 | 394 | 506 | 112 | 91 | 1.23 | 529 |

The influence of different contents of Cu on ΔTₓ can be seen from Table 2. In the range of 0.6-1.3 at %, ΔTₓ gradually increased (from 120° C. to 142° C.) with the increase of the content of Cu, that is, the heat treatment window obviously increased. Based on the heat Q₁ released from the first crystallization peak, the heat treatment characterization parameter κ was calculated, and the minimum value of κ was 1.38. After stacking ten strips, a highest temperature after continuous temperature increase Tₘₐₓ of the first crystallization of each embodiment was measured. It can be seen that Tₘₐₓ of each embodiment did not exceed the second crystallization temperature Tₓ₂. The highest temperature after continuous temperature increase Tₘₐₓ of the first crystallization refers to the highest temperature of the alloy under the action of the heat released during the first crystallization (i.e. Q₁).

Embodiments 4 and 5 show the influence of different contents of B, Si, P and C on the thermal properties of the amorphous alloy. As shown in Table 2, the content of B, Si, P and C has little influence on the thermal properties, and the thermal properties of the amorphous alloy are mainly affected by the content of Cu.

It can be seen from the comparative examples that when the content of Cu was lower than 0.6 at % or higher than 1.3 at %, the values of λ were 0.5, 1.87 and 1.25 respectively. In this case, the maximum value of ΔT was 102° C., and the heat treatment characterization parameter κ was smaller than or equal to 1.11. Tₘₐₓ of the comparative examples all exceeded the second crystallization start temperature, because the first crystallization gave off a lot of heat, and the released heat triggered the second crystallization peak, which led to continuous temperature increase till the sample burned down.

The amorphous alloy strip was subjected to heat treatment and performance testing, and for the specific process, the above introduction can be used as a reference. Performance testing results are shown in Table 3. After heat treatment, the saturation magnetic induction and coercivity were measured, and then the magnetic properties of the loops (under the excitation condition of 1.5 T/50 HZ) were measured with a B—H tester: iron-loss per unit weight Ps and unit excitation power Ss. The grain size was calculated with XRD analysis software.

TABLE 3
Magnetic properties and grain size

| | | | | | | | Grain |
|---|---|---|---|---|---|---|---|
| | | | Bs | Hc | Ps | Ss | size |
| No. | Alloy composition | λ | (T) | (A/m) | (W/kg) | (VA/kg) | (nm) |
| Embodiment 1 | Fe_{83.8}B₁₀Si_{0.5}P_{3.5}C_{1.0}Cu_{0.6}Nb_{0.6} | 1.00 | 1.803 | 7.3 | 0.273 | 0.831 | 27 |
| Embodiment 2 | Fe_{83.2}B₁₀Si_{0.5}P_{3.5}C_{1.0}Cu_{1.0}Nb_{0.8} | 1.25 | 1.812 | 6.2 | 0.245 | 0.628 | 23 |
| Embodiment 3 | Fe_{82.8}B₁₀Si_{0.5}P_{3.5}C_{1.0}Cu_{1.3}Nb_{0.9} | 1.40 | 1.795 | 7.2 | 0.267 | 0.759 | 25 |
| Embodiment 4 | Fe_{82.9}B_{9.5}Si_{1.0}P_{2.6}C_{1.2}Cu_{1.1}Nb_{0.9} | 1.22 | 1.771 | 8.3 | 0.300 | 0.812 | 26 |
| Embodiment 5 | Fe_{82.8}B_{9.6}Si_{0.5}P_{4.2}C_{0.8}Cu_{1.2}Nb_{0.9} | 1.33 | 1.784 | 6.9 | 0.294 | 0.771 | 27 |
| Comparative example 1 | Fe_{83.7}B₁₀Si_{0.5}P_{3.5}C_{1.0}Cu_{0.5}Nb_{0.8} | 0.63 | 1.802 | 8.9 | 0.456 | 0.952 | 39 |
| Comparative example 2 | Fe_{82.8}B₁₀Si_{0.5}P_{3.5}C_{1.0}Cu_{1.4}Nb_{0.8} | 1.75 | 1.763 | 10.3 | 0.596 | 1.216 | 42 |
| Comparative example 3 | Fe_{82.3}B₁₀Si_{0.5}P_{3.5}C_{1.0}Cu_{1.5}Nb_{1.2} | 1.25 | 1.753 | 12.5 | 0.661 | 1.512 | 36 |
| Comparative example 4 | Fe_{79.6}B₁₃Si_{1.3}P_{2.8}C_{1.1}Cu_{1.0}Nb_{1.2} | 0.83 | 1.732 | 9.6 | 0.781 | 1.254 | 41 |

It can be seen from Table 3 that the saturation magnetic induction Bs of Embodiment 1-5 was greater than or equal to 1.75 T. When the content of Cu was in the range of 0.6-1.3 at %, the iron-loss per unit weight Ps of the embodiments after heat treatment was obviously lower than that of the comparative examples, and the unit excitation power Ss of the embodiments was also lower than that of the comparative examples.

XRD analysis showed that the grain size of the alloy was 23-27 nm when the content of Cu was 0.6-1.3 at %. Through the comparative examples, it can be seen that when the content of Cu was beyond this range, abnormal growth of grains cannot be restrained because of relatively few macro-atoms, and the grain size was greater than 35 nm, and the abnormal growth of grains is also a factor affecting the magnetic properties of materials.

Combined with thermal properties such as κ and λ and magnetic properties such as Ps, Ss and grain size, the preferred range of the content of Cu was 0.6-1.3 at %.

II. Verify the Role and Control Range of Nb

The alloy composition of each embodiment and comparative example are shown in Table 4. Among the alloy components, the content of each element is atomic percentage.

Amorphous alloy strips of each embodiment and comparative example in Table 4 can be prepared and subjected to heat treatment according to the scheme shown in FIG. 1, which comprises the following steps.

21. Blending

Blending was performed according to the composition of each embodiment and comparative example shown in Table 2. The required industrial raw materials were pure Fe, pure Cu, elemental Si, pure C and Fe—B and Fe—P alloys, and the purity of the raw materials is shown in Table 1.

22. Smelting

The raw materials were weighed according to a mass ratio, and then added into a heating furnace (specifically, an intermediate frequency induction heating furnace) for melting. During the melting process, an inert gas (such as argon) was introduced as a protective gas, and after melting, the materials stood for 30 min to ensure that the composition of molten steel was uniform without segregation. In one example, the total mass of raw materials was 200 kg.

23. Single-Roll Rapid Quenching for Strip Preparation

An amorphous alloy thin strip was prepared by a copper roll rapid quenching method, that is, the molten steel was poured at 1400-1500° C., an amorphous nanocrystalline strip was obtained by the copper roll rapid quenching method, and the prepared amorphous nanocrystalline strip was wound into loops. As an example, an inner diameter of the loops may be 65 mm, and an outer diameter may be 70 mm. In the embodiments of this specification, the thin strip may also be called strip.

24. Heat Treatment

The amorphous alloy thin strip prepared above was subjected to heat treatment. Heat treatment may also be called crystallization annealing treatment, which is to promote the amorphous alloy to produce nano-scale grains, so as to prepare the amorphous nanocrystalline alloy. Specifically, during heat treatment or crystallization annealing, a temperature 20-30° C. higher than a first crystallization start temperature of the amorphous alloy was set as a heating target temperature. For example, the heating target temperature may be 420° C. As an example, in order to ensure the uniformity of temperature rise, the heat treatment process of the amorphous alloy was divided into two stages. In a first stage, the temperature of the amorphous alloy thin strip was increased to 280° C., and the temperature was kept for 2 h. In a second stage, the temperature of the amorphous alloy thin strip was increased to the heating target temperature at a rate of 30° C./min, and the temperature was kept for 30-40 min. Finally, the temperature was reduced at a rate of 50° C./s, and after cooling to room temperature, the amorphous nanocrystalline alloy thin strip can be obtained. To prevent oxidation during heat treatment, the above heat treatment process was performed in an inert gas (such as argon) atmosphere.

Thus, the strips in each embodiment or comparative example in Table 4 were prepared.

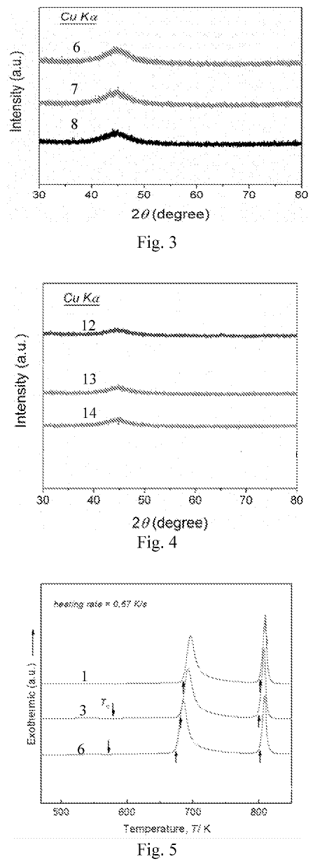

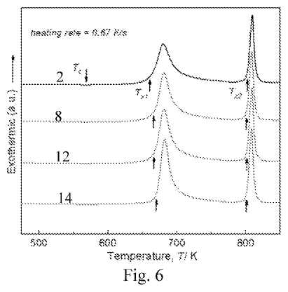

The above-mentioned XRD analysis was used to verify whether the prepared amorphous alloy strip was a completely amorphous structure. Verification results are shown in FIG. 3, from which it can be seen that only a broadened diffuse scattering peak appeared at about 45°, which indicates that the alloy sample was a completely amorphous structure.

DSC analysis results are shown in Table 4. Two obvious exothermic peaks appeared in the DSC curves of the samples, and a start temperature of a first exothermic peak and a start temperature of a second exothermic peak were Tₓ₁ and Tₓ₂ respectively, based on which ΔTx was obtained. An area of the first exothermic peak can be calculated, so that the heat release Q₁ of the alloy during first crystallization can be calculated, and then the heat treatment characteristic parameter κ can be obtained.

TABLE 4
Thermal properties and heat treatment process

| | | | Tₓ₁ | Tₓ₂ | ΔTₓ | Q₁ | | Tₘₐₓ |
|---|---|---|---|---|---|---|---|---|
| No. | Alloy composition | λ | (° C.) | (° C.) | (° C.) | J/g | κ | ° C. |
| Embodiment 6 | Fe_{83.7}B₁₀Si_{0.5}P_{3.5}C_{1.0}Cu_{0.8}Nb_{0.6} | 1.33 | 403 | 523 | 120 | 79 | 1.39 | 509 |
| Embodiment 7 | Fe_{83.3}B₁₀Si_{0.5}P_{3.5}C_{1.0}Cu_{1.0}Nb_{0.75} | 1.33 | 389 | 531 | 142 | 65 | 2.18 | 518 |
| Embodiment 8 | Fe_{83.2}B₁₀Si_{0.5}P_{3.5}C_{1.0}Cu_{1.0}Nb_{0.8} | 1.25 | 389 | 521 | 131 | 86 | 1.57 | 519 |
| Embodiment 9 | Fe₈₃B_{9.5}Si_{0.5}P_{4.2}C_{1.2}Cu_{0.8}Nb_{0.8} | 1.00 | 399 | 524 | 125 | 82 | 1.52 | 505 |
| Embodiment 10 | Fe_{82.1}B_{11.2}Si_{0.9}P_{3.0}C_{1.0}Cu_{1.0}Nb_{0.8} | 1.25 | 386 | 520 | 134 | 79 | 1.69 | 512 |
| Embodiment 11 | Fe_{83.4}B_{10.6}Si_{0.5}P_{2.8}C_{0.8}Cu_{1.0}Nb_{0.9} | 1.11 | 378 | 521 | 143 | 86 | 1.66 | 501 |
| Comparative example 5 | Fe8_{3.7}B₁₀Si_{0.5}P_{3.5}C_{1.0}Cu_{1.0}Nb_{0.3} | 3.33 | 396 | 487 | 91 | 99 | 0.92 | 561 |
| Comparative example 6 | Fe_{82.8}B₁₀Si_{0.5}P_{3.5}C_{1.0}Cu_{1.0}Nb_{1.2} | 0.83 | 385 | 470 | 85 | 105 | 0.81 | 549 |
| Comparative example 7 | Fe_{82.8}B₁₀Si_{0.5}P_{3.5}C_{1.0}Cu_{0.6}Nb_{0.8} | 0.75 | 401 | 498 | 97 | 91 | 1.07 | 548 |
| Comparative example 8 | Fe_{80.2}B₁₃Si_{0.5}P_{3.5}C_{1.0}Cu_{1.0}Nb_{0.8} | 1.25 | 409 | 511 | 102 | 88 | 1.16 | 536 |

Table 4 shows the influence of different contents of Nb on ΔTₓ. In the range of 0.6-0.9 at %, with the increase of Nb, ΔTₓ showed no obvious linear relationship, but ΔTₓ was above 120° C. When the content of Nb was lower than 0.6 at % or greater than 0.9 at %, the heat treatment window ΔTx was obviously smaller. Based on the heat Q₁ released from the first crystallization peak, the heat treatment characterization parameter κ was calculated, and the minimum value of κ was 1.39. After stacking ten strips, a highest temperature after continuous temperature increase T. of the first crystallization of each embodiment was measured. It can be seen that Tₘₐₓ of each embodiment did not exceed the second crystallization temperature Tₓ₂.

It can be seen from the comparative examples that when the content of Nb was lower than 0.6 at % or higher than 0.9 at %, the values of λ were 3.33, 0.83 and 0.75 respectively. In this case, the maximum value of ΔTₓ was 105° C., and the heat treatment characterization parameter κ was smaller than or equal to 1.07. Tₘₐₓ all exceeded the second crystallization start temperature, because the first crystallization gave off a lot of heat, and the released heat triggered the second crystallization peak, which led to continuous temperature increase till the sample burned down.

The amorphous alloy strip was subjected to heat treatment and performance testing, and for the specific process, the above introduction can be used as a reference. Performance testing results are shown in Table 5. After heat treatment, the saturation magnetic induction and coercivity were measured, and then the magnetic properties of the loops (under the excitation condition of 1.5 T/50 HZ) were measured with a B—H tester: iron-loss per unit weight Ps and unit excitation power Ss. The grain size was calculated with XRD analysis software.

TABLE 5
Magnetic properties and grain size

| | | | | | | | Grain |
|---|---|---|---|---|---|---|---|
| | | | Bs | Hc | Ps | Ss | size |
| No. | Alloy composition | λ | (T) | (A/m) | (W/kg) | (VA/kg) | (nm) |
| Embodiment 6 | Fe_{83.7}B₁₀Si_{0.5}P_{3.5}C_{1.0}Cu_{0.8}Nb_{0.6} | 1.33 | 1.834 | 7.8 | 0.286 | 0.756 | 30 |
| Embodiment 7 | Fe_{83.3}B₁₀Si_{0.5}P_{3.5}C_{1.0}Cu_{1.0}Nb_{0.75} | 1.33 | 1.814 | 6.2 | 0.248 | 0.622 | 23 |
| Embodiment 8 | Fe_{83.2}B₁₀Si_{0.5}P_{3.5}C_{1.0}Cu_{1.0}Nb_{0.8} | 1.25 | 1.812 | 6.2 | 0.245 | 0.628 | 23 |
| Embodiment 9 | Fe₈₃B_{9.5}Si_{0.5}P_{4.2}C_{1.2}Cu_{0.8}Nb_{0.8} | 1.00 | 1.781 | 7.3 | 0.268 | 0.802 | 26 |
| Embodiment 10 | Fe_{82.1}B_{11.2}Si_{0.9}P_{3.0}C_{1.0}Cu_{1.0}Nb_{0.8} | 1.25 | 1.756 | 6.9 | 0.275 | 0.658 | 27 |
| Embodiment 11 | Fe_{83.4}B_{10.6}Si_{0.5}P_{2.8}C_{0.8}Cu_{1.0}Nb_{0.9} | 1.11 | 1.821 | 8.1 | 0.255 | 0.743 | 29 |
| Comparative example 5 | Fe8_{3.7}B₁₀Si_{0.5}P_{3.5}C_{1.0}Cu_{1.0}Nb_{0.3} | 3.33 | 1.816 | 9.5 | 0.569 | 0.962 | 33 |
| Comparative example 6 | Fe_{82.8}B₁₀Si_{0.5}P_{3.5}C_{1.0}Cu_{1.0}Nb_{1.2} | 0.83 | 1.786 | 8.3 | 0.741 | 1.221 | 43 |
| Comparative example 7 | Fe_{82.8}B₁₀Si_{0.5}P_{3.5}C_{1.0}Cu_{0.6}Nb_{0.8} | 0.75 | 1.765 | 10.6 | 0.911 | 1.051 | 39 |
| Comparative example 8 | Fe_{80.2}B₁₃Si_{0.5}P_{3.5}C_{1.0}Cu_{1.0}Nb_{0.8} | 1.25 | 1.429 | 15.6 | 0.861 | 1.102 | 36 |

It can be seen from Table 5 that the saturation magnetic induction Bs of the each embodiment was greater than or equal to 1.75 T. When the content of Nb was in the range of 0.6-0.9 at %, the iron-loss per unit weight Ps of each embodiment was lower than that of the comparative examples, and the unit excitation power Ss of each embodiments was also lower than that of the comparative examples.

XRD analysis showed that when the content of Nb was in the range of 0.6-0.9 at %, the grain size was 23-30 nm. The addition of Nb improved the thermal stability of the amorphous phase. When the content of Nb in the alloy exceeded 0.6-0.9 at %, grains grew abnormally during the heat treatment of the alloy.

Combined with thermal properties such as κ and λ and magnetic properties such as Ps, Ss and grain size, the preferred range of the content of Nb was 0.6-0.9 at %.

III. Verify the Influence and Control Range of the Ratio of Cu to Nb

The alloy composition of each embodiment and comparative example is shown in Table 6. Among the alloy components, the content of each element is atomic percentage.

The preparation and heat treatment of the amorphous alloy strip can be performed as described above, which will not be repeated here.

The above-mentioned XRD analysis was used to verify whether the prepared amorphous alloy strip was a completely amorphous structure. Verification results are shown in FIG. 4, from which it can be seen that only a broadened diffuse scattering peak appeared at about 45°, which indicates that the alloy sample was a completely amorphous structure.

DSC analysis results are shown in Table 6. Two obvious exothermic peaks appeared in the DSC curves of the samples, and a start temperature of a first exothermic peak and a start temperature of a second exothermic peak were Tₓ₁ and Tₓ₂ respectively, based on which ΔTₓ was obtained. An area of the first exothermic peak can be calculated, so that the heat release Q₁ of the alloy during first crystallization can be calculated, and then the heat treatment characteristic parameter κ can be obtained.

TABLE 6
Thermal properties and heat treatment process

| | | | Tₓ₁ | Tₓ₂ | ΔTₓ | Q₁ | | Tₘₐₓ |
|---|---|---|---|---|---|---|---|---|
| No. | Alloy composition | λ | (° C.) | (° C.) | (° C.) | J/g | κ | ° C. |
| Embodiment 12 | Fe_{82.3}B₁₀Si_{0.5}P_{3.5}C_{1.0}Cu_{0.7}Nb_{0.61} | 1.15 | 393 | 519 | 126 | 90 | 1.40 | 516 |
| Embodiment 13 | Fe_{83.4}B₁₀Si_{0.5}P_{3.5}C_{1.0}Cu_{0.8}Nb_{0.8} | 1.00 | 389 | 531 | 142 | 84 | 1.69 | 520 |
| Embodiment 14 | Fe_{83.6}B₁₀Si_{0.5}P_{3.5}C_{1.0}Cu_{0.8}Nb_{0.6} | 1.33 | 401 | 521 | 120 | 79 | 1.52 | 511 |
| Embodiment 15 | Fe_{83.3}B_{9.5}Si_{0.6}P_{4.3}C_{0.9}Cu_{0.84}Nb_{0.6} | 1.40 | 411 | 534 | 123 | 76 | 1.62 | 521 |
| Embodiment 16 | Fe_{83.4}B_{9.1}Si_{0.9}P_{3.9}C_{1.1}Cu_{0.8}Nb_{0.8} | 1.00 | 399 | 529 | 130 | 83 | 1.57 | 516 |
| Embodiment 17 | Fe_{83.8}B_{9.6}Si_{0.5}P_{3.6}C_{1.0}Cu_{0.8}Nb_{0.64} | 1.25 | 390 | 519 | 129 | 91 | 1.42 | 511 |
| Comparative example 9 | Fe_{82.3}B₁₀Si_{0.5}P_{3.5}C_{1.0}Cu_{0.8}Nb_{1.2} | 0.67 | 390 | 505 | 105 | 96 | 1.09 | 569 |
| Comparative example 10 | Fe_{82.3}B₁₀Si_{0.5}P_{3.5}C_{1.0}Cu_{0.6}Nb_{0.9} | 0.67 | 401 | 499 | 98 | 87 | 1.13 | 541 |
| Comparative example 11 | Fe_{82.3}B₁₀Si_{0.5}P_{3.5}C_{1.0}Cu_{1.3}Nb_{0.75} | 1.73 | 410 | 501 | 91 | 81 | 1.12 | 532 |
| Comparative example 12 | Fe_{82.3}B₁₀Si_{0.5}P_{3.5}C_{1.0}Cu_{0.8}Nb_{0.9} | 0.90 | 408 | 510 | 102 | 76 | 1.34 | 546 |

It can be seen from Table 6 that the ratio of Cu to Nb affected λ and ΔTₓ, where λ represents the ratio of the number of Cu atoms to the number of Nb atoms. In the range of 1≤λ≤1.4, with the increase of Nb, ΔTₓ showed no obvious linear relationship, but ΔTₓ was greater than 120° C. in all cases. When λ was less than 1 or greater than 1.4, ΔTₓ decreased obviously. According to the heat release Q₁ of the first crystallization, the heat treatment characterization parameter κ was calculated, and the minimum value of κ was 1.40.

After stacking ten strips, the highest temperature after continuous temperature increase Tₘₐₓ of the first crystallization of each embodiment was measured. It can be seen that T. of each embodiment did not exceed the second crystallization temperature Tₓ₂.

It can be seen from the comparative examples that when the values of λ were 0.67, 0.67 and 1.73 respectively, the maximum value of ΔTₓ was 105° C., and the heat treatment characterization parameter κ was smaller than or equal to 1.09. Tₘₐₓ all exceeded the second crystallization start temperature, because the first crystallization gave off a lot of heat, and the released heat triggered the second crystallization peak, which led to continuous temperature increase till the sample burned down.

The amorphous alloy strip was subjected to heat treatment and performance testing, and for the specific process, the above introduction can be used as a reference. Performance testing results are shown in Table 7. After heat treatment, the saturation magnetic induction and coercivity were measured, and then the magnetic properties of the loops (under the excitation condition of 1.5 T/50 HZ) were measured with a B—H tester: iron-loss per unit weight Ps and unit excitation power Ss. The grain size was calculated with XRD analysis software.

TABLE 7
Magnetic properties and grain size

| | | | | | | | Grain |
|---|---|---|---|---|---|---|---|
| | | | Bs | Hc | Ps | Ss | size |
| No. | Alloy composition | λ | (T) | (A/m) | (W/kg) | (VA/kg) | (nm) |
| Embodiment 12 | Fe_{82.3}B₁₀Si_{0.5}P_{3.5}C_{1.0}Cu_{0.7}Nb_{0.61} | 1.15 | 1.798 | 7.2 | 0.266 | 0.685 | 29 |
| Embodiment 13 | Fe_{83.4}B₁₀Si_{0.5}P_{3.5}C_{1.0}Cu_{0.8}Nb_{0.8} | 1.00 | 1.815 | 6.2 | 0.249 | 0.627 | 23 |
| Embodiment 14 | Fe_{83.6}B₁₀Si_{0.5}P_{3.5}C_{1.0}Cu_{0.8}Nb_{0.6} | 1.33 | 1.806 | 6.5 | 0.278 | 0.667 | 29 |
| Embodiment 15 | Fe_{83.3}B_{9.5}Si_{0.6}P_{4.3}C_{0.9}Cu_{0.84}Nb_{0.6} | 1.40 | 1.832 | 8.6 | 0.254 | 0.753 | 25 |
| Embodiment 16 | Fe_{83.4}B_{9.1}Si_{0.9}P_{3.9}C_{1.1}Cu_{0.8}Nb_{0.8} | 1.00 | 1.802 | 7.6 | 0.268 | 0.654 | 28 |
| Embodiment 17 | Fe_{83.8}B_{9.6}Si_{0.5}P_{3.6}C_{1.0}Cu_{0.8}Nb_{0.64} | 1.25 | 1.786 | 5.8 | 0.287 | 0.801 | 22 |
| Comparative example 9 | Fe_{82.3}B₁₀Si_{0.5}P_{3.5}C_{1.0}Cu_{0.8}Nb_{1.2} | 0.67 | 1.795 | 8.8 | 0.356 | 0.991 | 39 |
| Comparative example 10 | Fe_{82.3}B₁₀Si_{0.5}P_{3.5}C_{1.0}Cu_{0.6}Nb_{0.9} | 0.67 | 1.809 | 10.3 | 0.664 | 0.897 | 40 |
| Comparative example 11 | Fe_{82.3}B₁₀Si_{0.5}P_{3.5}C_{1.0}Cu_{1.3}Nb_{0.75} | 1.73 | 1.761 | 15.2 | 0.766 | 1.211 | 38 |
| Comparative example 12 | Fe_{82.3}B₁₀Si_{0.5}P_{3.5}C_{1.0}Cu_{0.8}Nb_{0.9} | 0.90 | 1.763 | 9.6 | 0.436 | 0.930 | 32 |

It can be seen from Table 7 that the saturation magnetic induction Bs of each embodiment was greater than or equal to 1.75 T. When X, was in the range of 1-1.4, the iron-loss per unit weight Ps of each embodiments was lower than that of the comparative examples, and the unit excitation power Ss of each embodiments was also lower than that of the comparative examples.

XRD analysis showed that when X, was in the range of 1-1.4, the grain size of each embodiment was 22-29 nm. When X, was not in the range of 1-1.4, the grain size was larger.

Combined with thermal properties and magnetic properties of the alloy, the preferred range of λ was 1-1.4.

IV. Observe the Amorphous Forming Ability of Different Types of Alloy Composition

The thickness of the strip was used to characterize the amorphous forming ability of corresponding alloy composition of the strip. Table 8 shows the amorphous forming ability of different types of alloy composition.

TABLE 8
Comparison of amorphous forming ability

| | | | Characterization of | |
|---|---|---|---|---|
| No. | Alloy composition | Thickness | amorphous forming ability | Notes |
| Embodiment 1 | Fe_{83.4}B₁₀Si_{0.5}P_{3.5}C_{1.0}Cu_{0.8}Nb_{0.8} | 32 | ◯ | |
| Comparative example 1 | Fe_{83.7}B₁₀Si_{0.5}P_{3.5}C_{1.0}Cu_{0.5}Nb_{0.8} | 28 | Δ | |
| Comparative example 2 | Fe_{82.8}B₁₀Si_{0.5}P_{3.5}C_{1.0}Cu_{1.4}Nb_{0.8} | 27 | Δ | |
| Embodiment 6 | Fe_{83.7}B₁₀Si_{0.5}P_{3.5}C_{1.0}Cu_{0.8}Nb_{0.6} | 33 | ◯ | |
| Comparative example 5 | Fe_{83.7}B₁₀Si_{0.5}P_{3.5}C_{1.0}Cu_{1.0}Nb_{0.3} | 26 | Δ | |
| Comparative example 6 | Fe_{82.8}B₁₀Si_{0.5}P_{3.5}C_{1.0}Cu_{1.0}Nb_{1.2} | 24 | φ | |
| Embodiment 12 | Fe_{82.3}B₁₀Si_{0.5}P_{3.5}C_{1.0}Cu_{0.7}Nb_{0.61} | 33 | ◯ | |
| Comparative example 9 | Fe_{82.3}B₁₀Si_{0.5}P_{3.5}C_{1.0}Cu_{0.8}Nb_{1.2} | 23 | φ | |
| Comparative example 10 | Fe_{82.3}B₁₀Si_{0.5}P_{3.5}C_{1.0}Cu_{0.6}Nb_{0.9} | 26 | Δ | |

Note:
“◯” indicates that the amorphous forming ability is great, and the thickness of the prepared strip or thin strip is greater than or equal to 30 μm;
“φ” indicates that the amorphous forming ability is good, and the thickness of the prepared strip or thin strip is 25-30 μm; and
“Δ” indicates that the amorphous forming ability is the poorest, and the thickness of the prepared strip or thin strip is smaller than or equal to 25 μm.

As shown in FIG. 8, the amorphous forming ability of each embodiments was obviously better than that of the comparative examples, and the maximum thickness reached 33 μm, which indicates that the amorphous forming ability of the strip made according to the alloy composition with κ and λ being limited was obviously better than that of other types of composition.

In the above experiments, through verification based on different contents of Cu, it can be seen that with the increase of the content of Cu, the range of ΔTₓ gradually increased, and the broadness of the heat treatment window increased, which can prevent continuous temperature increase. By controlling the content of Cu to be 0.6-1.3 at %, ΔTₓ can be guaranteed to be higher than 120° C. When the content of Cu was not in this range, ΔTₓ decreased obviously.

When the heat treatment characterization parameter κ was greater than or equal to 1.38, the heat treatment window obviously increased, and Tₘₐₓ≤Tₓ₂ can be guaranteed. Nb is a large atom element, which can inhibit the precipitation of a primary crystal phase in an amorphous precursor, and inhibit excessive growth of atoms and control the grain size during heat treatment. The addition of Nb improves the thermal stability of the amorphous phase. By controlling the content of Nb, it is verified that when the atomic fraction of Nb in an alloy system containing P ranges from 0.6 to 0.9 at %, ΔTₓ is greater than 110° C., which can meet the requirements of heat treatment. In addition, by configuring different ratios of Cu atoms to Nb atoms, it is verified that the ratio of Cu atoms to Nb atoms should be 1-1.4 in order to ensure a wide heat treatment window ΔTₓ greater than 120° C. When the ratio of Cu atoms to Nb atoms was between 1 and 1.4, the heat treatment interval (i.e., ΔTₓ) increased, which is beneficial to industrial heat treatment. In other words, in order to make the alloy form a nanocrystalline structure with a small grain size and uniform distribution in a wider crystallization temperature zone (i.e., ΔTₓ), different ratios of the macro-atomic element Nb to other elements were configured, and it is verified that when the ratio of Cu atoms to Nb atoms was 1≤λ≤1.4, the minimum grain size was 23 nm.

In addition, the saturation magnetic induction Bs of the above-mentioned each embodiment was greater than 1.75 T. By controlling the content of main elements such as Cu and Nb, the grain size after heat treatment can be controlled, and the grain size was 20-30 nm.

To sum up, in the embodiments of this specification, element composition was limited and the composition range of the alloy was determined by means of the heat treatment characterization parameters κ≥1.38 and 1≤κ≤1.4. The maximum amorphous forming ability of the prepared strip was 33 μm, the heat treatment window was greater than or equal to 120° C., the Bs of the heat-treated strip was greater than or equal to 1.75 T, and the grain size of nanocrystals was controlled to be 20-30 nm. Besides, the iron core loss of the Fe-based amorphous alloy was less than 0.30 W/kg under the condition of 50 Hz and 1.5 T.

It can be understood that the various numerical symbols involved in the embodiments of this specification are only for convenience of description, and are not used to limit the scope of the embodiments of this specification.

1. An Fe-based amorphous nanocrystalline alloy, comprising elements, atomic percentages of which are as shown by formula (1):
Fe_{(100-a-b-c-d-e-f)}BₐSi_{b}P_{c}C_{d}CuₑNb_{f} (1);
where 8≤a≤12, 0.2≤b≤6, 2.0≤c≤6.0, 0.5≤d≤4, 0.6≤e≤1.3, 0.6≤f≤0.9, and 1≤e/f≤1.4.

2. The Fe-based amorphous nanocrystalline alloy according to claim 1, wherein the Fe-based amorphous nanocrystalline alloy is in a continuous thin strip shape, and a strip thickness of the thin strip is greater than or equal to 30 μm.

3. The Fe-based amorphous nanocrystalline alloy according to claim 1, wherein a temperature difference between a second crystallization start temperature and a first crystallization start temperature of the Fe-based amorphous nanocrystalline alloy is greater than 120° C.

4. The Fe-based amorphous nanocrystalline alloy according to claim 3, wherein a ratio of the temperature difference to first heat is greater than or equal to 1.38, the first heat is heat released by the Fe-based amorphous nanocrystalline alloy during first crystallization, the unit of the temperature difference is Celsius, and the unit of the first heat is J/g.

5. The Fe-based amorphous nanocrystalline alloy according to claim 1, wherein the saturation magnetic induction of the Fe-based amorphous nanocrystalline alloy is greater than or equal to 1.75 T, the iron-loss per unit weight of the Fe-based amorphous nanocrystalline alloy is less than 0.30 W/kg under an excitation condition of 50 Hz-1.5 T, and
in the Fe-based amorphous nanocrystalline alloy, a size of nanocrystalline grains is 20-30 nm.

6. A preparation method of the Fe-based amorphous nanocrystalline alloy according to claim 1, comprising the following steps:
(a) blending according to the atomic percentages of elements shown by formula (1), and then smelting to obtain molten steel;
(b) performing single-roll rapid quenching on the molten steel to obtain an initial strip;
(c) heating the initial strip to a first preset temperature which is 20-30° C. higher than a first crystallization start temperature of the initial strip;
(d) holding the temperature for 30-40 min; and
(e) cooling the initial strip to obtain the Fe-based amorphous nanocrystalline alloy;
wherein
Fe_{(100-a-b-c-d-e-f)}BₐSi_{b}P_{c}C_{d}CuₑNb_{f} (1);
where 8≤a≤12, 0.2≤b≤6, 2.0≤c≤6.0, 0.5≤d≤4, 0.6≤e≤1.3, 0.6≤f≤0.9, and 1≤e/f≤1.4.

7. The preparation method according to claim 6, wherein heating the initial strip to a first preset temperature comprises:
heating the initial strip to a second preset temperature, and holding the temperature for a preset time, the second preset temperature being lower than the first preset temperature; and
heating the initial strip from the second preset temperature to the first preset temperature at a first preset heating rate.

8. The preparation method according to claim 7, wherein the second preset temperature is 280° C., the preset time is 2 h, and
the first preset heating rate is 30° C./min.

9. The preparation method according to claim 6, wherein in step (e), the initial strip is cooled at a cooling rate of 50° C./s.

10. A magnetic component composed of the Fe-based amorphous nanocrystalline alloy according to claim 1.

11. The Fe-based amorphous nanocrystalline alloy according claim 2, wherein the saturation magnetic induction of the Fe-based amorphous nanocrystalline alloy is greater than or equal to 1.75 T, the iron-loss per unit weight of the Fe-based amorphous nanocrystalline alloy is less than 0.30 W/kg under an excitation condition of 50 Hz-1.5 T, and
in the Fe-based amorphous nanocrystalline alloy, a size of nanocrystalline grains is 20-30 nm.

12. The Fe-based amorphous nanocrystalline alloy according claim 3, wherein the saturation magnetic induction of the Fe-based amorphous nanocrystalline alloy is greater than or equal to 1.75 T, the iron-loss per unit weight of the Fe-based amorphous nanocrystalline alloy is less than 0.30 W/kg under an excitation condition of 50 Hz-1.5 T, and
in the Fe-based amorphous nanocrystalline alloy, a size of nanocrystalline grains is 20-30 nm.

13. The Fe-based amorphous nanocrystalline alloy according claim 4, wherein the saturation magnetic induction of the Fe-based amorphous nanocrystalline alloy is greater than or equal to 1.75 T, the iron-loss per unit weight of the Fe-based amorphous nanocrystalline alloy is less than 0.30 W/kg under an excitation condition of 50 Hz-1.5 T, and
in the Fe-based amorphous nanocrystalline alloy, a size of nanocrystalline grains is 20-30 nm.

14. A preparation method of the Fe-based amorphous nanocrystalline alloy according to claim 2, comprising the following steps:
(a) blending according to the atomic percentages of elements shown by formula (1), and then smelting to obtain molten steel;
(b) performing single-roll rapid quenching on the molten steel to obtain an initial strip;
(c) heating the initial strip to a first preset temperature which is 20-30° C. higher than a first crystallization start temperature of the initial strip;
(d) holding the temperature for 30-40 min; and
(e) cooling the initial strip to obtain the Fe-based amorphous nanocrystalline alloy;
wherein
Fe_{(100-a-b-c-d-e-f)}BₐSi_{b}P_{c}C_{d}CuₑNb_{f} (1);
where 8≤a≤12, 0.2≤b≤6, 2.0≤c≤6.0, 0.5≤d≤4, 0.6≤e≤1.3, 0.6≤f≤0.9, and 1≤e/f≤1.4.

15. A preparation method of the Fe-based amorphous nanocrystalline alloy according to claim 3, comprising the following steps:
(a) blending according to the atomic percentages of elements shown by formula (1), and then smelting to obtain molten steel;
(b) performing single-roll rapid quenching on the molten steel to obtain an initial strip;
(c) heating the initial strip to a first preset temperature which is 20-30° C. higher than a first crystallization start temperature of the initial strip;
(d) holding the temperature for 30-40 min; and
(e) cooling the initial strip to obtain the Fe-based amorphous nanocrystalline alloy;
wherein
Fe_{(100-a-b-c-d-e-f)}BₐSi_{b}P_{c}C_{d}CuₑNb_{f} (1);
where 8≤a≤12, 0.2≤b≤6, 2.0≤c≤6.0, 0.5≤d≤4, 0.6≤e≤1.3, 0.6≤f≤0.9, and 1≤e/f≤1.4.

16. A preparation method of the Fe-based amorphous nanocrystalline alloy according to claim 4, comprising the following steps:
(a) blending according to the atomic percentages of elements shown by formula (1), and then smelting to obtain molten steel;
(b) performing single-roll rapid quenching on the molten steel to obtain an initial strip;
(c) heating the initial strip to a first preset temperature which is 20-30° C. higher than a first crystallization start temperature of the initial strip;
(d) holding the temperature for 30-40 min; and
(e) cooling the initial strip to obtain the Fe-based amorphous nanocrystalline alloy;
wherein
Fe_{(100-a-b-c-d-e-f)}BₐSi_{b}P_{c}C_{d}CuₑNb_{f} (1);
where 8≤a≤12, 0.2≤b≤6, 2.0≤c≤6.0, 0.5≤d≤4, 0.6≤e≤1.3, 0.6≤f≤0.9, and 1≤e/f≤1.4.

17. A preparation method of the Fe-based amorphous nanocrystalline alloy according to claim 5, comprising the following steps:
(a) blending according to the atomic percentages of elements shown by formula (1), and then smelting to obtain molten steel;
(b) performing single-roll rapid quenching on the molten steel to obtain an initial strip;
(c) heating the initial strip to a first preset temperature which is 20-30° C. higher than a first crystallization start temperature of the initial strip;
(d) holding the temperature for 30-40 min; and
(e) cooling the initial strip to obtain the Fe-based amorphous nanocrystalline alloy;
wherein
Fe_{(100-a-b-c-d-e-f)}BₐSi_{b}P_{c}C_{d}CuₑNb_{f} (1);
where 8≤a≤12, 0.2≤b≤6, 2.0≤c≤6.0, 0.5≤d≤4, 0.6≤e≤1.3, 0.6≤f≤0.9, and 1≤e/f≤1.4.

18. The preparation method according to claim 7, wherein in step (e), the initial strip is cooled at a cooling rate of 50° C./s.

19. The preparation method according to claim 8, wherein in step (e), the initial strip is cooled at a cooling rate of 50° C./s.

20. A magnetic component composed of the Fe-based amorphous nanocrystalline alloy according to claim 2.
